(19) United States
(12) Patent Application Publication
(10) Pub. No.: US 2026/0355975 A1
(43) Pub. Date: Nov. 12, 2026

(54) SUBSTRATE TRANSFER APPARATUS AND SUBSTRATE TRANSFER METHOD

(71) Applicants: KAWASAKI JUKOGYO KABUSHIKI KAISHA, Kobe-shi (JP); Kawasaki Robotics (USA), INC., Wixom, MI (US)

(72) Inventors: Haruhiko TAN, Kobe-shi (JP); Hajime NAKAHARA, San Jose, CA (US); Luc NGUYEN, Pleasanton, CA (US)

(73) Assignees: KAWASAKI JUKOGYO KABUSHIKI KAISHA, Kobe-shi (JP); Kawasaki Robotics (USA), INC., Wixom, MI (US)

(21) Appl. No.: 19/200,789

(22) Filed: May 7, 2025

(51) Int. Cl. B25J 11/00; B25J 15/00; B25J 15/06

(52) U.S. Cl. CPC B25J 11/0095; B25J 15/0042; B25J 15/008; B25J 15/0658

(57) ABSTRACT

The substrate transfer apparatus according to one or more embodiments may include: a base, an elevator connected to the base to be freely raised and lowered, and a substrate transfer mechanism including a hand that is movably connected to the elevator and transports the substrate. In the substrate transfer apparatus according to one or more embodiments, the hand includes the following: substrate contact portions that grip the substrate; and adhesion pads that protrude from the hand and adheres to the substrate and are stored in the hand and does not adhere to the substrate, the substrate contact portions may secure the substrate based on the adhesion pads stored in the hand.

### BACKGROUND

The disclosure relates to a substrate transfer apparatus and a substrate transfer method, and in particular, to a technique for stably transporting a substrate.

A plurality of manufacturing apparatus are used when manufacturing semiconductor substrates, liquid crystal substrates, panels, and the like (hereinafter collectively referred to as simply “substrates”). Transfer devices are used to transport substrates between these manufacturing devices. Substrate transfer devices are widely used as industrial robots.

U.S. Pat. No. 10,875,190 (Cutkosky) discloses pads for use, augmentation, or retrofitting in robotic manipulators. In Cutkosky, the pad identifies a dry adhesive layer with a dry adhesive wedge that interfaces with the object to be manipulated. The plurality of dry adhesive wedges are arranged in such a way that the pattern has at least two different directions for the direction of the plurality of wedges. The pad further identifies the sensor array under the dry adhesive layer. The data obtained from the sensor array provides an estimate of the shape and size of the contact between the adhesion pad and the object when the dry adhesive layer is in contact with the object.

### SUMMARY

A substrate transfer apparatus according to one or more embodiments may include: a base, an elevator connected to the base to be freely raised and lowered, and a substrate transfer mechanism including a hand that is movably connected to the elevator and transports the substrate, in a substrate transfer apparatus according to one or more embodiments, the hand may include: a substrate contact portion that grips a substrate, and an adhesion pad that protrudes from the hand and adheres to the substrate and are stored in the hand so as not to adhere to the substrate, wherein the substrate contact portions may secure the substrate based on the adhesion pad stored in the hand.

A substrate transfer method according to one or more embodiments may include: placing a substrate in contact with adhesion pads included in the hand of the substrate transfer apparatus, transferring the substrate while the substrate is placed on the hand, storing the adhesion pads inside the hand, placing the substrate without contacting the adhesion pad, so as to be in contact with the substrate contact portions provided in the hand, and transferring the substrate while the substrate is placed on the hand.

### BRIEF DESCRIPTION OF DRAWINGS

FIG. 1 is a diagram illustrating an upper surface of a substrate transfer apparatus according to one or more embodiments.

FIG. 2 is a diagram illustrating a top view of a hand included in the substrate transfer apparatus according to one or more embodiments.

FIGS. 3A and 3B are A-A cross-sectional views such as is shown in FIG. 2.

FIG. 4 is a flowchart illustrating a substrate transfer method according to one or more embodiments.

FIG. 5 is a diagram illustrating a substrate transfer method according to one or more embodiments.

FIG. 6 is a diagram illustrating a perspective view of a substrate transfer apparatus according to one or more embodiments.

FIG. 7 is a diagram illustrating a perspective view of a substrate transfer apparatus according to one or more embodiments.

FIG. 8 is a diagram illustrating a partially fractured perspective view of a substrate transfer apparatus according to one or more embodiments.

### DETAILED DESCRIPTION

The substrate transfer apparatus according to one or more embodiments is described in detail with reference to the drawings. In the description of the drawings, identical or similar parts may be denoted by the same or similar numerals. The description in the drawing is schematic, and the relationship between thickness and dimensions, the ratio of the length and thickness of each part, etc. are examples, and do not limit the scope of technical concept. Dimensional relationships and dimension ratios may vary between drawings. In the following description, when explaining the positional relationship of each component, “top”, “bottom”, “right side”, “left side”, etc. are appropriately used based on the orientation of the drawing to be referenced and the specific object, but these indications do not limit the scope of technical thought. Expressions such as “top”, “bottom”, “right side”, “left side”, etc. may be used even when each part is not touched. “Longitudinal direction” may mean the direction of the long side on the main surface of the member. “Width direction” may mean the direction of the short side on the main surface of the member. “Height direction” or “vertical direction” may mean a direction related to the thickness of the main surface of the member. Further, the substrate includes, for example, a semiconductor wafer and a glass wafer, and the semiconductor wafer includes a silicon wafer, a sapphire (single crystal alumina) wafer, and various other wafers and panels.

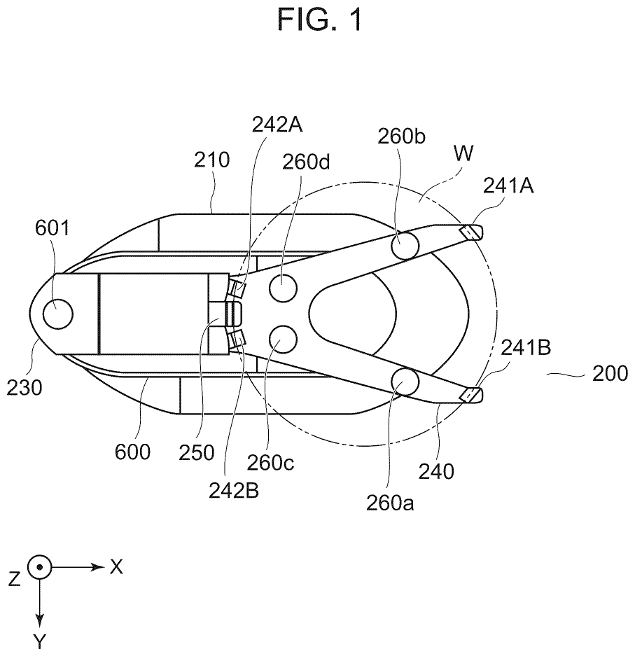

FIG. 1 is a diagram showing the upper surface of the substrate transfer apparatus 200 according to one or more embodiments. The substrate transfer apparatus 200 includes the base 210, an elevator, and a substrate transfer mechanism for transporting the substrate. The elevator is provided to elevate and lower the link 600 and the end effector 230 freely in the vertical direction (Z direction shown). The substrate transfer mechanism includes a link 600 rotatably connected to the base 210, and the end effector 230 that is rotatably connected around the rotating shaft 601 and transports the substrate W. Although, the substrate transfer apparatus 200 of FIG. 1 illustrates only one link 600, but may include two, three, four, and five links 600. Further, the substrate transfer apparatus 200 may not include a link 600 and may directly connect the end effector 230 to an elevator (not shown). Further, the substrate transfer apparatus 200 may not include an elevator and may be directly connected to one or more links to the base 300. The substrate transfer apparatus 200 of FIG. 1 particularly indicates a horizontally articulated substrate transfer apparatus, but is not limited to this, and a so-called direct-acting substrate transfer apparatus that does not have a joint or a rotator may also be implemented. In the substrate transfer apparatus 200, various operations are controlled by a controller (not shown). The controller performs various operation controls including lifting and lowering operations and rotation operations of the elevator, link 600, and end effector 230.

The end effector 230 includes the hand 240 that grips the substrate W and a plunger 250 that grips and aligns the substrate in contact with the substrate W. The hand 240 includes substrate contact portions 241a, 241b, 242a, and 242b. The plunger 250 may grip the substrate W. The end effector 230 acquires the substrate W from a predetermined position using the hand 240 under the control of the controller, and transports the substrate W to the predetermined position. When acquiring the substrate W stored in the FOUP (Front Opening Unified Pod) or the like, the hand 240 enters the upper or lower part of the substrate W, and when it is recognized that the hand 240 has entered to a predetermined position of the substrate W, the hand 240 stops approaching. Thereafter, a gripping operation of the substrate W may be performed. At this time, the plunger 250 may move and grip the substrate W. As a method for the hand 240 to grip the substrate W, a so-called edge grip method may be used. Thereby, the end effector 230 may grip the substrate W and convey the substrate W to a predetermined position. In the substrate transfer apparatus according to one or more embodiments, it may be implemented without including the plunger 250.

The hand 240 includes adhesion pads 260a, 260b, 260c, and 260d. The adhesion pads 260a, 260b, 260c, and 260d adhere to and grip the substrate W when the substrate W is placed on the hand 240. When the substrate W is placed on the hand 240, the substrate W and the adhesion pads 260a, 260b, 260c, and 260d are attached. The adhesion force of the adhesion pads 260a, 260b, 260c, and 260d stably hold the substrate W on the hand 240. When the hand 240 then moves the substrate W to a predetermined position, the substrate W is stably moved on the hand 240 by the adhesion force of the adhesion pads 260a, 260b, 60c, and 260d.

The adhesion pads 260a, 260b, 260c, and 260d move in the opposite direction to the Z direction shown and are stored in the hand 240 based on the control of the controller. When the adhesion pads 260a, 260b, 260c, and 260d are stored in the hand 240, the adhesion pads 260a, 260b, 260c, and 260d are separated from the substrate W and no longer adhere. The adhesion pads 260a, 260b, 260c, and 260d move in the Z direction shown and protrudes from the hand 240 based on the control of the controller. When the adhesion pads 260a, 260b, 260c, and 260d protrudes from the hand 240, the adhesion pads 260a, 260b, 260c, and 260d adhere to and grip the substrate W. Thus, based on the control of the controller, the adhesion pads 260a, 260b, 260c, and 260d may control the adhesion of the substrate W on the hand 240 by protruding from the hand 240 and adhering to the substrate, and by being retracted into the hand and not adhering to the substrate.

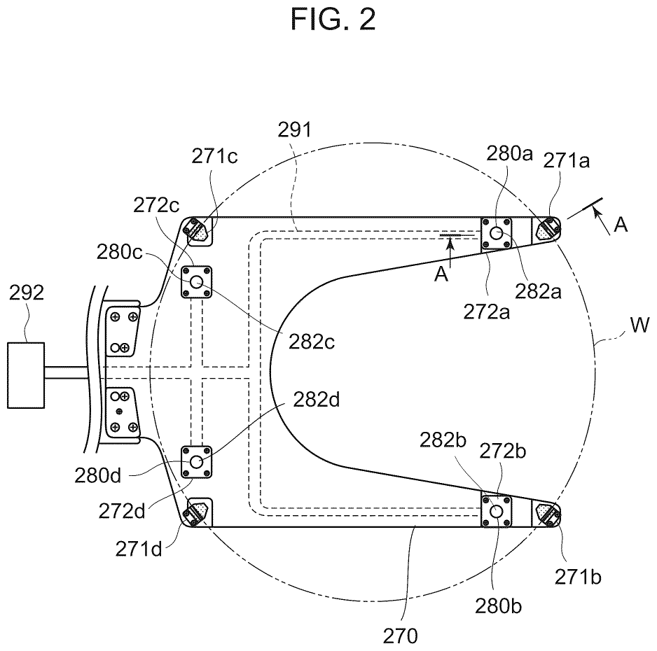

FIG. 2 is a diagram illustrating a top view of a hand 270 included in a substrate transfer apparatus according to one or more embodiments. The hand 270 includes substrate contact portions 271a, 271b, 271c, and 271d, and adhesion pads 280a, 280b, 280c, and 280d. The hand 270 includes two branched portions for stably gripping the substrate W. The substrate contact portions 271a, 271b, 271c, and 271d are placed on the hand 270 in contact with the substrate W. Substrate contact portions 271a and 271b are placed near the tips of the two branched portions. Further, substrate contact portions 271c and 271d are placed near the base of the hand 270. When the substrate W is placed on the hand 270, the substrate contact portions 271a, 271b, 271c, and 271d guide the position where the substrate W is placed.

The adhesion pads 280a and 280b are placed near the tips of the two branched portions of the hand 270, and the adhesion pads 280c and 280d are placed near the base of the hand 270. The hand 270 includes covers 272a, 272b, 272c, and 272d. The covers 272a, 272b, 272c, and 272d each have openings arranged in substantially the center. The controller 292 controls the operation of the adhesion pads 280a, 280b, 280c, and 280d. Based on the control of the controller 292, the adhesion pads 280a, 280b, 280c, and 280d perform an outwardly protruding movement through the openings of the covers 272a, 272b, 272c, and 272d, and perform a retracted movement from the external to the inside. In FIG. 2, the hand 270 includes, but is not limited to, four adhesion pads 280a, 280b, 280c, and 280d. The hand 270 may be provided with one, two, three, five, six, seven, eight, or more adhesion pads.

The adhesion pads 280a, 280b, 280c, and 280d may include silicone rubber, elastomeric polyimide fiber, fluorine rubber, PEEK (Polyetheretherketone), or polyurethane. Further, the adhesion pads 280a, 280b, 280c, and 280d may use a technique using biomimetics (biomimetic technology) that analyzes and applies superior functions to engineering. For example, a reversible bonding technology that may repeatedly perform bonding and separation, an adhesive technology using Van der waals force, and a dry bonding technology that exhibits adhesive power without using a sticky liquid.

The hand 270 includes a passage 291 that transmits control of the controller 292 to the adhesion pads 280a, 280b, 280c, and 280d. The passage 291 is connected to a controller 292 external to the hand 270 from the adhesion pads 280a, 280b, 280c, and 280d. The operation of the adhesion pads 280a, 280b, 280c, and 280d is controlled by the controller 292 through a passage 291 provided inside the hand 270. As shown in FIG. 2, the passage 292 is connected to the controller 292 from near the base of the hand 270. The passage 292 branches from near the base of the hand 270 and is connected to the adhesion pads 280a, 280b, 280c, and 280d. Not limited to the configuration of the passage 291 shown in FIG. 2, each of the passages 291 from the adhesion pads 280a, 280b, 280c, and 280d may be connected to the controller 292. In this case, the controller 292 may be able to perform individual operation control for each adhesion pad 280a, 280b, 280c, and 280d. The passage 291 may be arranged on the top, back, or inside of the hand 270.

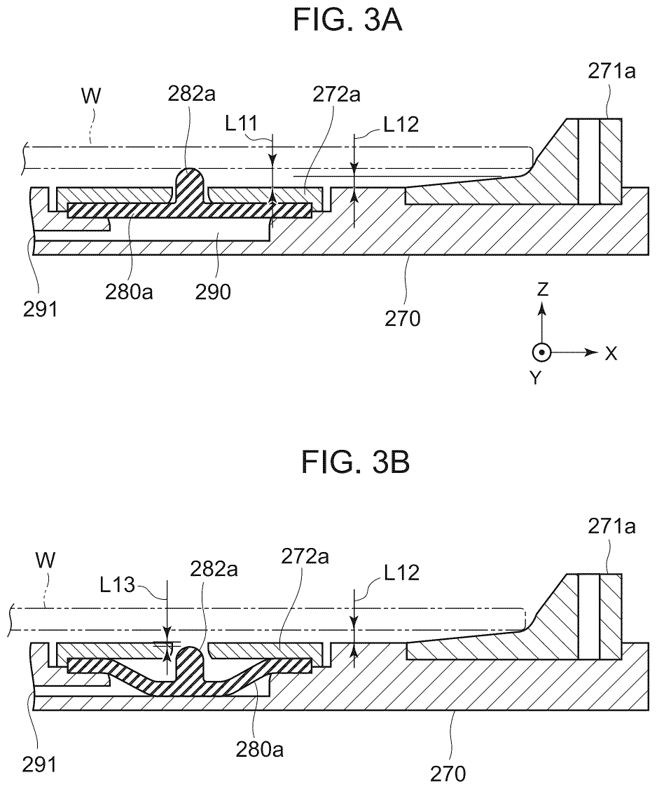

FIG. 3A is a diagram illustrating an A-A cross-sectional view of FIG. 2, for example. In FIG. 3A, the substrate contact portion 271a is placed near the tip of the hand 270 in the X-axis direction. The substrate contact portion 271a is placed so as to be embedded in the hand 270, and the bottom surface of the substrate contact portion 271a and the hand 270 are connected at a position lower than the surface of the hand 270. The substrate contact portion 271a holds the substrate W at a higher position than the surface of the hand 270. The substrate contact portion 271a has a sloped surface and has an upward slope as it proceeds in the tip direction, which is in the X-axis direction of the hand 270. Further, the side wall in which the substrate contact portion 271a is in contact with the substrate W has a tapered shape in which the cross-sectional area continuously decreases toward the upper end that is in the Z-axis direction of the substrate contact portion 271a. The hand 270 has a cavity 290 therein. The upper part of the cavity 290 is sealed by an adhesion pad 280a. The cavity 290 is connected to the passage 291. The inside of the passage 291 forms a continuous hollow space extending from the cavity 290. Thereby, the air pressure in the cavity 290 changes by controlling the air pressure in the passage 291. The adhesion pad 280a includes a flat plate shaped flat portion and the tip portion 282a in the substantially center of the flat portion. The flat plate-shaped end of the adhesion pad 280a is sandwiched between the hand 270 and the cover 272a. Thereby, the cavity 290 has a structure having a sealed state blocked from the external environment. As shown in FIG. 3A, the side wall of the substrate contact portion 271a in contact with the substrate W has a tapered shape, but is not limited thereto. The side wall of the substrate contact portion 271a may be vertical. In other words, the side wall of the substrate contact portion 271a may be substantially equal to the Z-axis direction.

In FIG. 3A, the tip portion 282a of the adhesion pad 280a protrudes externally from the opening of the cover 272a. The tip portion 282a of the protruding adhesion pad 280a adheres to and grips the substrate W when the substrate W is placed on the hand 270. In the state of FIG. 3A, the tip portion 282a of the adhesion pad 280a protrudes outward beyond the surface of the cover 272a. Therefore, the Substrate W Is Placed Slightly Above by the Tip Portion 282a of the adhesion pad 280a.

The tip portion 282a of the adhesion pad 280a grips the substrate W by adhesion force. The tip portion 282a may adhere to the substrate W by adhesive force and friction force. The adhesion force may refer to the force that adheres to the substrate W at least one of the adhesive force or friction force. Therefore, the tip portion 282a may adhere to the substrate W by either adhesive force or friction force. Here, the adhesive force may be defined as the force that pulls off two bonded objects. The friction force may be defined as the force generated when two objects come into contact and try to move relatively. The adhesive force generates a force that resists forces in various directions. On the other hand, the friction force generates a force in the opposite direction to the direction of motion of two objects.

In FIG. 3A, when the substrate W is placed on the hand 270, the tip portion 282a of the adhesion pad 280a adheres to the substrate W and grips. For example, when high accuracy is required for the placement of the substrate W, such as transportation from the pre-aligner device to the load lock device, the adhesion pad 280a having high adhesion protrudes. Thereby, the misalignment of the substrate W may be reduced.

FIG. 3B is a diagram illustrating an A-A cross-sectional view of FIG. 2, for example. In FIG. 3B, based on the control of the controller 292, the tip portion 282a of the adhesion pad 280a is retracted and moved into the hand 270 inside from the surface of the cover 272a. In FIG. 3B, the tip portion 282a of the adhesion pad 280a is stored below the surface of the cover 272a. The distance between the tip portion 282a of the adhesion pad 280a and the surface of the cover 272a is L13. In the substrate transfer apparatus according to one or more embodiments, the tip portion 282a of the adhesion pad 280a moves to a position lower than the surface of the cover 272a. However, it is not limited to this, and the position of the tip portion 282a of the adhesion pad 280a may be moved to a position where it does not touch the substrate W. The tip portion 282a of the adhesion pad 280a is stored, and the substrate contact portion 271a secures the substrate W. When the substrate contact portion 271a secures the substrate W, the substrate W may be placed slightly downward. In this case, the distance L11 between the cover 272a and the substrate W in the state of FIG. 3A may be longer than the distance L12 between the cover 272a and the substrate W in the state of FIG. 3B.

The distance between the cover 272a and the substrate W at the position of the substrate W is L11, the distance between the surface of the hand 270 and the substrate W at the position of the substrate W is L12, and the distance between the tip portion 282a of the adhesion pad 280a and the surface of the cover 272a is L13. In this case, it may be preferable for the distance L11 to be longer than the distance L12 in terms of being able to secure the distance L13. The L11 may be longer than 0 mm and less than 10 mm. Further, L11 may preferably be 0.5 mm or more and 5 mm or less, and L11 may be preferably 1 mm or more and 2 mm or less. When the tip portion 282a is stored in the cover 272a, the L13 may be 0 mm or less, that is, the same height or less as the surface of the cover 272a, preferably 0.5 mm or less, 1 mm or less.

In FIG. 3B, the tip portion 282a of the adhesion pad 280a is stored, and the substrate W is adjacent to the substrate contact portion 271a on the hand 270. The substrate contact portions 271a, 271b, 271c, and 271d have lower adhesion force than the adhesion pad 280a. For example, when high accuracy is not required for the placement of the substrate W, such as transportation from the load port device to the pre-aligner device or from the load lock device to the load port device, the adhesion pad 280a having high adhesion force is stored, the substrate contact portions 271a, 271b, 271c, and 271d secures the substrate W. Thereby, it may be achieved to process transferring the substrate W and handling to other devices at high speed.

As shown in FIG. 2, the tip portions 282a, 282b, 282c, and 282d of the adhesion pads 280a, 280b, 280c, and 280d are circular when viewed from above, but may be implemented without limitation. If the protruding portions of the tip portions 282a, 282b, 282c, and 282d are small, the desired adhesion force may not be obtained. On the other hand, if the protruding portions of the tip portions 282a, 282b, 282c, and 282d are large, it may be difficult to peel off from the substrate W, and the throughput of handling the substrate W may be reduced. Furthermore, large protruding portions of the tip portions 282a, 282b, 282c, and 282d may increase the possibility of contaminating the substrate W. It may be preferable that the tip portions 282a, 282b, 282c, and 282d of the tip portions 282a, 282b, 282c and 282d according to one or more embodiments adhere to the substrate W in an area having a diameter of 2 mm to 30 mm, and may furthermore adhere to the substrate W in an area having a diameter of 5 mm to 15 mm with which the tip portion 285a contact the substrate W.

The controller 292 controls the operation of the adhesion pad 280a. In the substrate transfer apparatus according to one or more embodiments, the controller 292 controls the air pressure in the cavity 290 through the passage 291. For example, in the state of FIG. 3A, the controller 292 controls the cavity 290 to the first pressure. Next, when transitioning to the state of FIG. 3B, the controller 292 controls the air pressure of the cavity 290 to the second pressure which is lower than the first pressure. For example, when the first pressure is the ambient pressure at the place where the substrate transfer apparatus is installed, the second pressure may be a negative pressure lower than the ambient pressure. Further, when the first pressure is positive pressure, the second pressure may be the ambient pressure. Here, in order to reduce contamination from particulate matter, scientific substances, or biological substances from the substrate transfer environment, it may be preferable that the cavity 290 is in a negative pressure state at all times. For example, the controller 292 may control the cavity 290 to the first pressure that is a negative pressure lower than the ambient pressure, and to the second pressure lower than the first pressure.

For example, the controller may include a vacuum regulator for air pressure control of the cavity 290 of the controller 292. A vacuum regulator is a device that controls negative pressure to maintain a constant pressure. The vacuum regulator includes a pump that is a vacuum source, and may include a decompression unit that adjusts pressure, an outlet connected to the passage 291, and a sensor that detects pressure inside the cavity 290. When the controller 292 controls the first pressure, the cavity 290 is depressurized through the outlet by a decompression unit. When the sensor detects that the cavity portion 290 has reached the first pressure, the decompression unit stops depressurizing. Next, when the controller 292 controls to the second pressure, the controller 292 depressurizes or pressurizes the inside of the cavity 290 through the outlet by the decompression unit. When the sensor detects that the cavity portion 290 has reached the second pressure, the decompression unit stops depressurizing or pressurizing. The controller 292 may include the first decompression unit that controls the first pressure, the second decompression unit that controls the second pressure, and a switching valve for switching between the first pressure of the decompression unit or the second pressure of the second decompression unit. When the first pressure is the ambient pressure, a valve may be provided in the controller to return the negative pressure of the cavity 290 to the ambient pressure.

In FIG. 3A, when the controller 292 is controlled to the first pressure, the adhesion pad 280a is flat and substantially parallel to the cover 272a. Further, the cavity 290 has a sufficient area. The tip portion 282a of the adhesion pad 280a protrudes from the opening of the cover 272a, and the substrate W is in contact with the tip portion 282a. In this case, the distance between the substrate W and the cover 272a is L11. Next, in the state of FIG. 3B, that is, when the controller 292 is controlled at a second pressure lower than the first pressure, the adhesion pad 280a changes to a recessed shape toward the cavity 290 due to the difference in air pressure in the cavity 290 and the external air pressure. As the tip portion 282a moves in the opposite direction to the Z direction, the substrate W attached to the tip portion 282a also moves in the opposite direction to the Z direction. When the tip portion 282a moves further in the opposite direction to the Z direction, the tip portion 282a is released from adhesion to the substrate W, and moves away from the substrate W. The substrate W away from the tip portion 282a is in contact with the substrate contact portion 271a on the hand 270. In this case, the distance between the substrate W and the hand 270 is L12. The substrate contact portions 271a, 271b, 271c and 271d have a lower adhesion force than the adhesion pad 280a. In FIGS. 3A and 3B, the adhesion pad 280a has been described as an example, but the adhesion pads 280b, 280c and 280d in FIG. 2 may have the same configuration and operation.

As described above, according to the substrate transfer apparatus according to one or more embodiments, the adhesion pads 280a, 280b, 280c and 280d protrude from the hand 270 and adheres to the substrate W based on the control of the controller 292. For example, when high accuracy is required to reduce the deviation during transferring and to place the substrate W such as transportation from the pre-aligner device to the load lock device, the adhesion pads 280a, 280b, 280c and 280d having high adhesion grip the substrate W. On the other hand, based on the control of the controller 292, the adhesion pads 280a, 280b, 280c and 280d are stored in the hand 270 and no longer adhere to the substrate W. For example, when high accuracy is not required for the placement of the substrate W, such as transportation from the load port device to the pre-aligner device or from the load lock device to the load port device, the substrate contact portions 271b, 271b, 271, and 271d secure the substrate W. As a result, the adhesion force of the substrate W on the hand 270 is reduced, but the substrate transfer speed may be increased. Thus, by exposing and storing the adhesion pads 280a, 280b, 280c and 280d provided in the hand 270, the adhesion force at the time of transportation may be changed according to the required accuracy.

In other words, the adhesion force of the adhesion pads 280a, 280b, 280c and 280d are higher than the substrate contact portions 271a, 271b, 271c and 271d, however, there is a possibility that the position of the substrate may be misaligned when the substrate W is transported at high speed. When the hand 270 transports the substrate W at high speed, it may be necessary to consider the centrifugal force, acceleration force, deceleration force, and the like at the time of transportation. The substrate contact portions 271a, 271b, 271c and 271d include, for example, tray-shaped edges and side walls, and prevent deviation from the hand 270 due to the force applied to the substrate W during transport. That is, the substrate contact portions 271a, 271b, 271c and 271d do not grip by adhesion force, but physically secure the substrate W by the side wall in contact with the substrate W. Thereby, the hand 270 may be able to prevent the substrate W from popping out. As a result, the hand 270 may be able to stably transport the substrate W even when transporting at high speed. In the above, the adhesion pad 280a has been described, but the same configuration may be used for the other adhesion pads 280b and 280c. The following description also may apply to other adhesion pads than those described above.

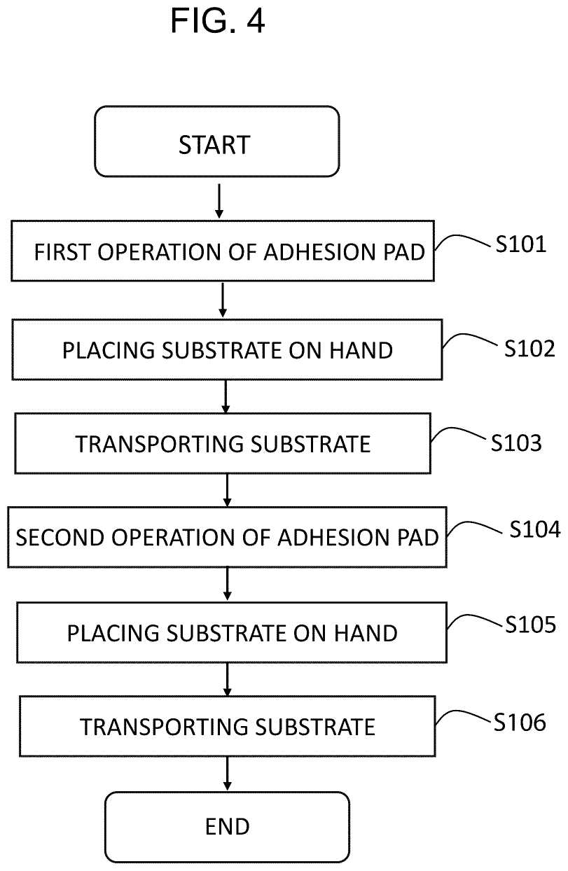

FIG. 4 is a diagram illustrating a flowchart of a substrate transfer method according to one or more embodiments. First, the first operation is performed on the adhesion pad (step S101). In the first operation, for example, as shown in FIG. 3A, the tip portion 282a of the adhesion pad 280a protrudes outward from the opening of the cover 272a based on the control of the controller 292. When the tip portion 282a of the adhesion pad 280a protrudes outward from the opening of the cover 272a, the cavity 290 of the hand 270 is set to the first pressure by the control of the controller 292. Here, when it is not necessary to set the air pressure, such as when the first pressure is almost the ambient pressure, and the adhesion pad 280a already protrudes outward from the opening of the cover 272a, there may be no need to perform the first operation on the adhesion pad 280a. Therefore, in this case, step S101 is a step that does not necessarily require to be performed.

Next, the substrate W is placed on the hand 270 with the tip portion 282a of the adhesion pad 280a protruding outward from the opening of the cover 272a (step S102). At this time, the substrate W adheres to the tip portion 282a of the adhesion pad 280a. The protruding tip portion 282a of the adhesion pad 280a adheres to and grips the substrate W when the substrate W is placed on the hand 270.

Here, in the substrate transfer apparatus according to one or more embodiments, the substrate W is placed on the hand 270 with the tip portion 282a of the adhesion pad 280a protruding outward from the opening of the cover 272a (step S102), and then the first operation may be performed on the adhesion pad 280a (step S101).

Next, the substrate W is transferred (step S103). For example, when high accuracy is required for the placement of the substrate W, such as transportation from the pre-aligner device to the load lock device, the adhesion pad 280a having high adhesion protrudes. In other words, when the tolerance is small with respect to the misalignment of the substrate W, the adhesion pad 280a having high adhesion protrudes. Thereby, the misalignment of the substrate W may be reduced. At this time, the transfer speed of the substrate W is a relatively slow first speed.

Next, the second operation of the adhesion pad 280a is performed (step S104). In the second operation, for example, as shown in FIG. 3B, the tip portion 282a of the adhesion pad 280a stores and moves inside the hand 270 from the surface of the cover 272a based on the control of the controller 292. When the tip portion 282a of the adhesion pad 280a is moved to the inside of the hand 270 from the surface of the cover 272a, the cavity 290 of the hand 270 is set to the second pressure lower than the first pressure by the control of the controller 292. Thereby, due to the difference in air pressure between the air pressure of the cavity 290 and the external air pressure, the adhesion pad 280a changes to a shape recessed toward the cavity 290. Accordingly, the tip portion 282a is retracted from an opening in the cover 272a, and the substrate contact portions 271a, 271b, 271c and 271d on the hand 270 are in contact with the substrate W. The substrate contact portions 271a, 271b, 271c and 271d have a lower adhesion force than the adhesion pad 280a.

Next, the substrate W is placed on the hand 270 in a state where the tip portion 282a of the adhesion pad 280a is stored (step S105). At this time, the substrate contact portions 271a, 271b, 271c and 271d are attached to the substrate W. Since the tip portion 282a is stored, the substrate W does not touch the tip portion 282a.

Next, the substrate W is transferred (step S106). For example, when high accuracy is not required for the placement of the substrate W, such as transportation from the load port device to the pre-aligner device or from the load lock device to the load port device, the adhesion pad 280a having high adhesion is stored, and the substrate contact portions 271a, 271b, 271c and 271d secure the substrate W. In other words, in the case of transportation with a high tolerance with respect to the misalignment of the substrate W, the substrate W is transported with the adhesion pad 280a stored. Thereby, the substrate W may be transported at high speed, and the substrate W may be moved to the destination device at high speed. For example, the substrate W may be transported at the second speed which is faster than the first speed.

Here, when the substrate W is transferred in steps S103 and S106, the transferring speed may be changed. Further, in the substrate transfer apparatus according to one or more embodiments, the substrate W may be placed on the hand 270 (step S105) with the tip portion 282a of the adhesion pad 280a stored, and then the second operation of the adhesion pad may be performed (step S104). In particular, with regard to the operation control of the substrate transfer apparatus including a plurality of hands, reference is made to U.S. Pat. No. 12,036,680.

When a predetermined adhesion force may be obtained by exposing and storing the adhesion pad in the first operation and the second operation, for example, in the case of a transport with a low tolerance for misalignment of the substrate W, the adhesion pad protrudes and the substrate W is transported, and in the case of transport with a high tolerance for misalignment of the substrate W, the adhesion pad is stored and the substrate W is transported by securing the substrate W to the substrate contacting portion. By doing this, it may be possible to k the change in the transfer speed of the substrate W. Further, if the configuration is as described above, the change in the transfer speed of the substrate W may be constant. The description of the flowchart of FIG. 4 shows that the first operation of the adhesion pad protrudes the tip portion 282a of the adhesion pad 280a outward from the opening of the cover 272a. In the second operation of the adhesion pad, the tip portion 282a of the adhesion pad 280a is stored in the internal direction from the opening of the cover 272a. However, it is not limited to this, and the first operation of the adhesion pad may store the tip portion 282a of the adhesion pad 280a in the internal direction from the opening of the cover 272a. Further, the second operation of the adhesion pad may protrude the tip portion 282a of the adhesion pad 280a outward from the opening of the cover 272a.

In the substrate transfer method according to one or more embodiments as described above, the adhesion pad is moved to switch between adhesion and non-adhesion of the substrate W and the adhesion pad. When the adhesion pad adheres to the substrate W, it grips with higher adhesion. On the other hand, when the adhesion pad does not adhere to the substrate W, the substrate W is in contact with a substrate contact portion that has a lower adhesion force than the adhesion pad or does not have an adhesion force. The substrate contact portion secures the substrate W. By switching between adhesion and non-adhesion of the substrate W and the adhesion pad, it may be possible to change the adhesion force to the hand during substrate transfer depending on the required accuracy. Thereby, the productivity of the semiconductor apparatus may be improved by optimizing the transfer speed of the substrate W, and it may also be possible to contribute to reducing substrate damage during substrate transfer.

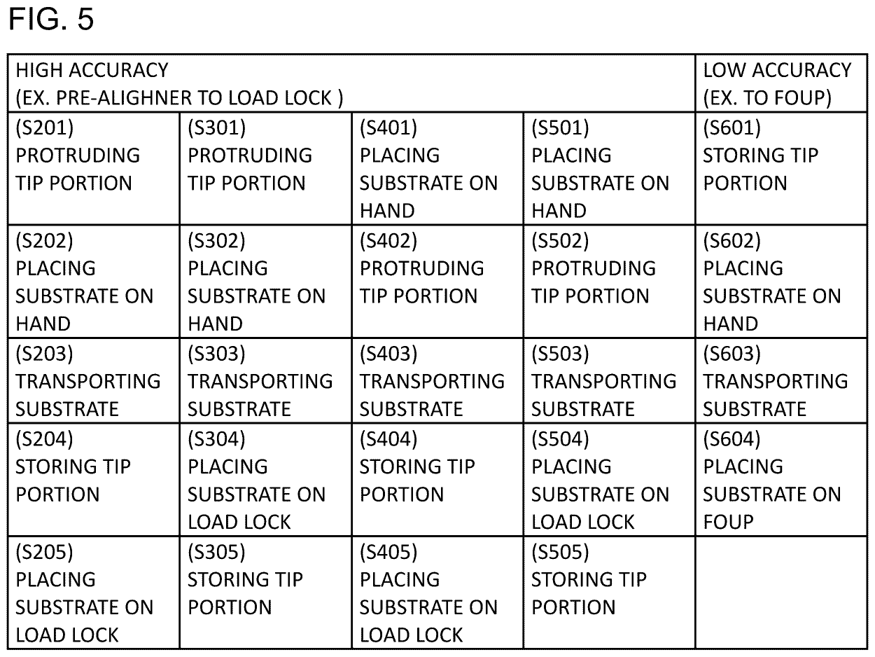

FIG. 5 is a diagram illustrating a substrate transfer method according to one or more forms. In FIG. 5, the hand 270 according to FIG. 2 is described as an example of a substrate transfer method related to transportation that requires high accuracy, such as a pre-aligner device to a load lock device, and a substrate transfer method related to transportation that does not require high accuracy, such as substrate transportation related to FOUP. In the following description, a load lock device will be described as an example as a transport destination where high accuracy is required, but is not limited thereto.

In the substrate transfer method when high accuracy is required according to one or more embodiments, as the first operation, based on the control of the controller 292, the tip portions 282a, 282b, 282c and 282d of the adhesion pads 280a, 280b, 280c and 280d protrude outward from the opening of the covers 272a, 272b, 272c and of 272d (step S201). Next, the substrate W is placed on the hand 270 with the tip portions 282a, 282b, 282c and 282d of the adhesion pads 280a, 280b, 280c and 280d protrude outward from the openings of the covers 272a, 272b, 272c and 272d (step S202). Then, the substrate W is transported (step S203). Next, as a second operation, based on the control of the controller 292, the tip portions 282a, 282b, 282c and 282d of the adhesion pads 280a, 280b, 280c and 280d are stored and moved into the hand 270 inside from the covers 272a, 272b, 272c and 272d surfaces (step S204). Next, the substrate W is placed on the load lock device with the tip portions 282a, 282b, 282c and 282d of the adhesion pads 280a, 280b, 280c and 280d stored (step S205).

In the substrate transfer method when high accuracy is required according to one or more embodiments is, as the first operation, based on the control of the controller 292, the tip portions 282a, 282b, 282c and 282d of the adhesion pads 280a, 280b, 280c and 280d protrude outward from the opening of the covers 272a, 272b, 272c and 272d (step S301). Next, the substrate W is placed on the hand 270 with the tip portions 282a, 282b, 282c and 282d of the adhesion pads 280a, 280b, 280c and 280d protrude outward from the openings of the covers 272a, 272b, 272c and 272d (step S302). Then, the substrate W is transported (step S303). Next, the substrate W is placed on the load lock device with the tip portions 282a, 282b, 282c and 282d of the adhesion pads 280a, 280b, 280c and 280d are protruding (step S304). Next, as the second operation, based on the control of the controller 292, the tip portions 282a, 282b, 282c and 282d of the adhesion pads 280a, 280b, 280c and 280d are stored and moved into the hand 270 inside from the covers 272a, 272b, 272c and 272d surfaces (step S305).

In the substrate transfer method when high accuracy is required according to one or more embodiments, first, the substrate W is placed on the hand 270 (step S401). Next, as the first operation, based on the control of the controller 292, the tip portions 282a, 282b, 282c and 282d of the adhesion pads 280a, 280b, 280c and 280d protrude outward from the openings of the covers 272a, 272b, 272c and 272d (step S402). Then, the substrate W is transported (step S403). Next, as the second operation, based on the control of the controller 292, the tip portions 282a, 282b, 282c and 282d of the adhesion pads 280a, 280b, 280c and 280d are stored and moved into the hand 270 inside from the covers 272a, 272b, 272c and 272d surfaces (step S404). Next, the substrate W is placed on the load lock device with the tip portions 282a, 282b, 282c and 282d of the adhesion pads 280a, 280b, 280c and 280d stored (step S405).

In the substrate transfer method when high accuracy is required according to one or more embodiments, first, the substrate W is placed on the hand 270 (step S501). Next, as the first operation, based on the control of the controller 292, the tip portions 282a, 282b, 282c and 282d of the adhesion pads 280a, 280b, 280c and 280d protrude outward from the openings of the covers 272a, 272b, 272c and 272d (step S502). Then, the substrate W is transported (step S503). Next, the substrate W is placed on the load lock device with the tip portions 282a, 282b, 282c and 282d of the adhesion pads 280a, 280b, 280c and 280d are protruding (step S504). Next, as the second operation, the tip portions 282a, 282b, 282c and 282d of the adhesion pads 280a, 280b, 280c and 280d are stored based on the control of the controller 292 (step S505).

Thus, in the substrate transfer method according to one or more embodiments, when transporting a pre-aligner device to a load lock device or the like that requires high accuracy, the adhesion pads protrude from the hand to increase the grip force of the substrate. Normally, during transfers requiring high accuracy, the speed is reduced to transport the substrate. According to the substrate transfer method according to one or more embodiments, the gripping force may be controlled by controlling the adhesion pad even during transfers requiring high accuracy. This may minimize the reduction in speed. As a result, the number of lots per unit passing through the production line and the time required to pass through the production line (Turn around time: TAT) may be improved.

Next, a substrate transfer method related to transportation that does not require high accuracy, such as substrate transportation to FOUP, is described. In the substrate transfer method when high accuracy is not required according to one or more embodiments, as a first operation, the tip portions 282a, 282b, 282c and 282d of the adhesion pads 280a, 280b, 280c and 280d are stored based on the control of the controller 292 (step S601). With the tip portions 282a, 282b, 282c and 282d of the adhesion pads 280a, 280b, 280c and 280d stored, the substrate W is placed on the hand 270 (step S602). Then, the substrate W is transported (step S603). Next, the substrate W is placed on the load lock device with the tip portions 282a, 282b, 282c and 282d of the adhesion pads 280a, 280b, 280c and 280d stored.

Thus, according to the substrate transfer method according to one or more embodiments, the adhesion pads are stored to lower the gripping force, and the substrate contact portions secure the substrate during transportation where high accuracy is not required, such as substrate transportation to FOUP. Although the grip force of the substrate is lower, the substrate is transferred at a faster speed during substrate transfer. Further, since the adhesion pads are not attached to the substrate, the substrate may be efficiently removed from the hand. In the substrate transfer method according to one or more embodiments, storing the adhesion pad, it may minimize the reduction in speed even during transportation where high accuracy is not required. As a result, the number of lots per unit passing through the production line and the time required to pass through the production line (Turn around time: TAT) may be improved.

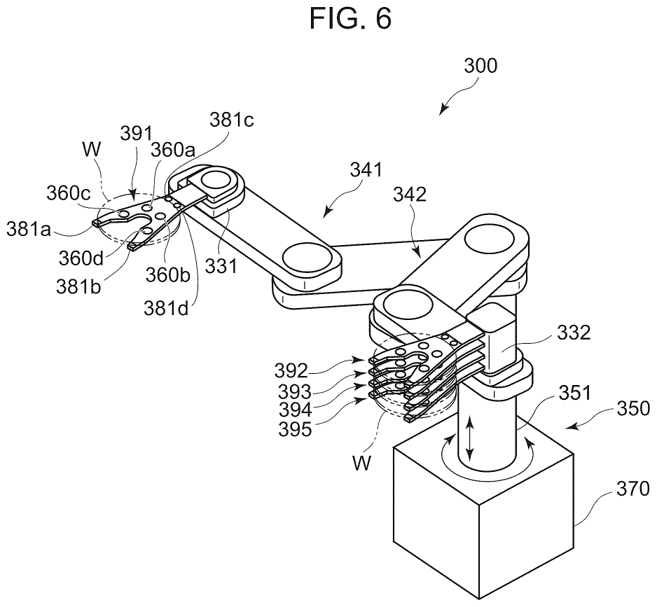

FIG. 6 is a diagram illustrating a substrate transfer apparatus 300 according to one or more embodiments. The substrate transfer apparatus 300 includes the base 370, the elevator 350, and a substrate transfer mechanism. The substrate transfer apparatus 300 is a substrate transfer apparatus having a horizontal articulation. That is, the substrate transfer apparatus 300 includes the first arm 341 and the second arm 342, which are horizontally articulated robot arms, as a substrate transfer mechanism. The first arm 341 and the second arm 342 each have two links. The two links are rotatably connected to each other horizontally. The first arm 341 and the second arm 342 are connected to the elevator 350. One end of the first arm 341 and the second arm 342 are rotatably connected along the horizontal direction to the lifting shaft 351 of the elevator 350. The elevator 350 moves the first arm 341 and the second arm 342 up and down by moving the lifting shaft 351 along the vertical direction. The first arm 341, the second arm 342, and the elevator 350 are operated by the driving force of a servo motor (not shown).

The first blade support 331 is provided at the other end of the first arm 341. Then, the second blade support 332 is provided at the other end of the second arm 342. The first blade support 331 is rotatably connected to the first arm 341 horizontally. Further, the second blade support 332 is rotatably connected to the second arm 342 horizontally.

In the substrate transfer apparatus 300, the first blade support 331 supports a blade 391. The second blade support 332 supports a plurality of blades 392, blades 393, blades 394, and blades 395. The substrate transfer apparatus 300 performs an operation of transporting a substrate W by the blade 391 supported by the first blade support 331, and an operation of simultaneously transporting a plurality of substrate W by a plurality of blades 392, 393, 394 and 395 supported by the second blade support 332.

The blade 391 includes the adhesion pad 360a, 360b, 360c and 360d that grips the placed substrate W. As in the structure of the hand 270 shown in FIG. 2, the blade 391 may include a passage. Further, the adhesion pads 360a, 360b, 360c and 360d may be configured to perform a protruding operation from the blade 391 and a storage operation to the blade 391. A cover including an opening may be provided on the surface of the blade 391, and the adhesion pads 360a, 360b, 360c and 360d may protrude and retracted from the opening of the cover. The adhesion pads 360a, 360b, 360c and 360d include a tip portion (not shown) having high adhesion, protruding from the blade 391, adhering to and gripping the substrate W. Further, based on the control of the controller, the adhesion pads 360a, 360b, 360c and 360d are stored in positions that are not in contact with the substrate W. At that time, the substrate contact portions 381a, 381b, 381c and 381d provided on the blade 391 are in contact with the substrate W. The substrate contact portions 381a, 381b, 381c and 381d have lower adhesion than the adhesion pads 360a, 360b, 360c and 360d. The adhesion pads 360a, 360b, 360c and 360d are controlled by the controller through a passage provided inside the blade 391 to perform protruding and storage operations. A passage leading from the adhesion pads 360a, 360b, 360c and 360d is connected to the controller. Under the control of the controller, the tip portions of the adhesion pads 360a, 360b, 360c and 360d protrude from the opening of the cover, and the substrate W is in contact with the tip portions of the adhesion pads 360a, 360b, 360c and 360d. Next, under the control of the controller, the tip portions of the adhesion pads 360a, 360b, 360c and 360d are stored from the opening of the cover, and when the substrate W is placed, the substrate W is in contact with the substrate contact portion of the blade 391.

Here, an example is described in which the blade 391 are arranged with the adhesion pads 360a, 360b, 360c and 360d that grip the placed substrate W. Not limited thereto, the adhesion pads 360a, 360b, 360c and 360d may be provided on the plurality of blades 392, 393, 394 and 395 of the second blade support 332.

As described above, in the substrate transfer apparatus according to one or more embodiments includes a plurality of arms, and based on the control of the controller 292, the adhesion pads 260a, 260b, 260c and 260d protrude from the hand 240 and adheres to the substrate, and is stored in the hand and does not adhere to the substrate, so that the adhesion force of the substrate W on the hand 240 may be controlled. Thus, by exposing and storing the adhesion pads 360a, 360b, 360c and 360d provided on the blade 391 and the plurality of blades 392, 393, 394 and 395, it may be possible to change the adhesion force at the time of transportation depending on the required accuracy. The entire contents of the international publication No. WO2023/210561, in particular the description of a substrate transfer apparatus having a plurality of arms, are incorporated herein by reference.

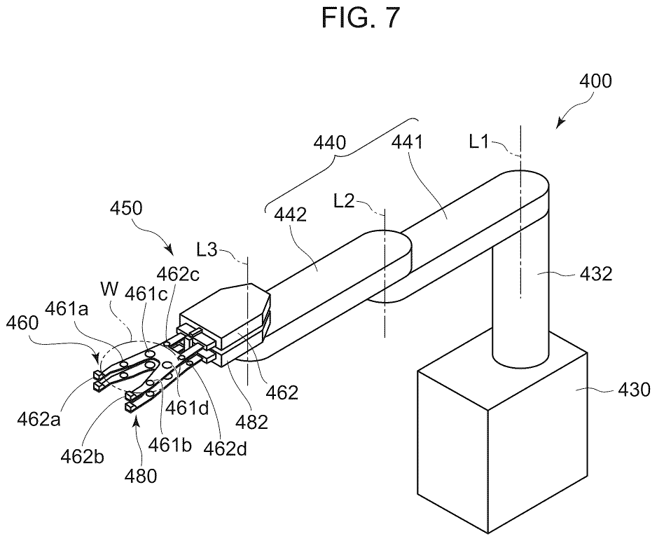

FIG. 7 is a diagram illustrating a perspective view of the substrate transfer apparatus 400 according to one or more embodiments. The substrate transfer apparatus 400 is a transfer robot for griping and transporting the semiconductor substrate W in a clean room where the semiconductor is manufactured. The substrate transfer apparatus 400 is a so-called horizontally articulated three-axis robot, including the base 430, the elevator 432 provided on the upper surface of the base 430, the arm 440 attached to the upper end of the elevator 432, and the end effector 450 attached to the wrist of the arm 440. The elevator 432 is arranged to be extendable in a vertical direction by an air cylinder (not shown) or the like. The elevator 432 is provided rotatable around the first rotation axis L1 extending vertically with respect to the base 430. The robot arm 440 includes the first link 441 and the second link 442, both of which include a long member extending horizontally. The first link 441 is attached to the upper end of the elevator 432 at an end of the longitudinal direction. The first link 441 is integrally raised and lowered with the elevator 432 and rotates around the first rotation axis integrally with the elevator 432. The second link 442 is rotatably attached around the second rotation axis L2 where the longitudinal end extends vertically to the other longitudinal end of the first link 441.

The end effector 450 is attached to the other end in the longitudinal direction (the wrist of the robot arm) of the second link 442. The end effector 450 includes the first end effector 460 and the second end effector 480 provided independently rotatable around the same third rotation axis L3 extending vertically. In one or more embodiments, the second end effector 480 is attached underneath the first end effector 460. The first end effector 460 and the second end effector 480 may have the same external shape as each other in a planar view. The first end effector 460 and the second end effector 480 each perform an operation of griping the substrate W independently of each other.

The first end effector 460 includes a first wrist axis (not shown) extending vertically about the third rotation axis L3, and the first end effector base 462 having a hollow structure connected to the upper end of the first wrist axis. The second end effector 480 is provided outside the first wrist axis, and includes the second wrist axis (not shown) extending in a vertical direction about the third rotation axis L3, and the second end effector base 482 having a hollow structure connected to the upper end of the second wrist axis.

The first end effector 460 is driven by a drive source including a servo motor or the like. The first end effector 460 rotates around the third rotation axis L3 extending vertically by the driving force generated by the drive source. Further, the second end effector 480 is driven by a drive source including a servo motor or the like. The second end effector 480 rotates around the third rotation axis L3 extending vertically by the driving force generated by the drive source. The first end effector 460 and the second end effector 480 may be rotated independently.

The hands of the first end effector 460 and the second end effector 480 include adhesion pads that grip the substrate W. FIG. 7 shows the adhesion pads 461a, 461b, 461c and 461d provided in the first end effector 460. The hands of the first end effector 460 and the second end effector 480 may include passages, such as the structure of the hand 270 shown in FIG. 2. Further, the adhesion pads 461a, 461b, 461c and 461d may be configured to perform a protruding operation from the hands of the first end effector 460 and the second end effector 480, and a storage operation in the hands of the first end effector 460 and the second end effector 480. A cover including an opening may be provided on the surface of the hand of the first end effector 460 and the second end effector 480, and the adhesion pads 461a, 461b, 461c and 461d may protrude and stored from the opening of the cover. Adhesion pads 461a, 461b, 461c and 461d include a tip portion having high adhesion (not shown), and protrude from the hands of the first end effector 460 and the second end effector 480 to grip the substrate W. Further, based on the control of the controller, the adhesion pads 461a, 461b, 461c and 461d are stored in a position that is not in contact with the substrate W. At that time, the substrate contact portions 462a, 462b, 462c and 462d on the hands of the first end effector 460 and the second end effector 480 are in contact with the substrate W. The substrate contact portions 462a, 462b, 462c and 462d have lower adhesion than the adhesion pads 461a, 461b, 461c and 461d. The adhesion pads 461a, 461b, 461c and 461d are controlled by the controller through the passage provided inside the hand of the first end effector 460 and the second end effector 480 to perform protruding and storage operations. The passage leading from the adhesion pads 461a, 461b, 461c and 461d is connected to the controller. Under the control of the controller, the tip portions of the adhesion pads 461a, 461b, 461c and 461d protrude from the opening of the cover, and the substrate W contacts the tip portions of the adhesion pads 461a, 461b, 461c and 461d. Next, under the control of the controller, the tip portions of the adhesion pads 461a, 461b, 461c and 461d are retracted from the opening of the cover, and when the substrate W is placed, the substrate contact portions 462a, 462b, 462c and 462d of the hands of the first end effector 460 and the second end effector 480 are in contact with the substrate W.

As described above, in the substrate transfer apparatus according to one or more embodiments, the robot arm 440 includes a hand of the first end effector 460 and a hand of the second end effector 480, and based on the control of the controller, the adhesion pads 461a, 461b, 461c and 461d protrude from the hand and adhere to the substrate W, and are stored in the hand and do not adhere to the substrate W, thereby controlling the adhesion of the substrate W on the hand. Thus, by exposing and storing the adhesion pads 461a, 461b, 461c and 461d, it may be possible to change the adhesion force at the time of transportation depending on the required accuracy. The entire contents of the U.S. Pat. No. 11,207,775, in particular the description of the substrate transfer apparatus having a plurality of hands, are incorporated herein by reference.

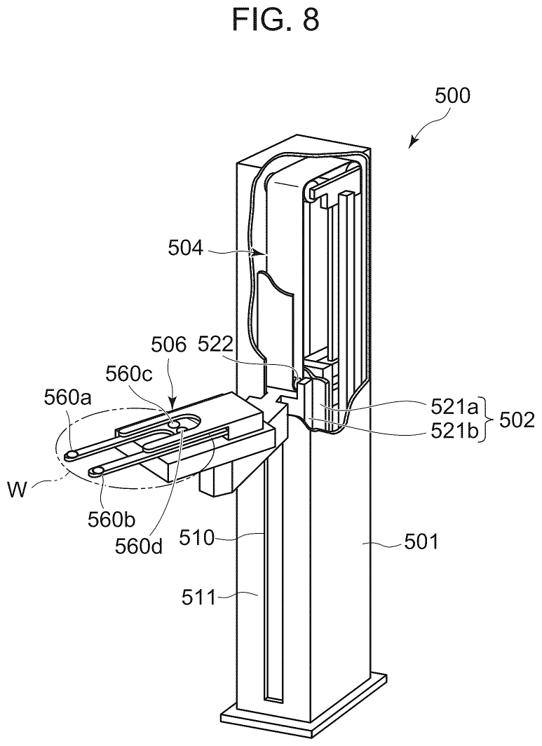

FIG. 8 is a diagram illustrating a partially fractured perspective view of the substrate transfer apparatus 500 according to one or more embodiments. The substrate transfer apparatus 500 is, for example, an apparatus used for transporting the substrate W in facilities for various processing such as heat treatment, impurity introduction treatment, thin film formation treatment, lithography treatment, cleaning treatment, and flattening treatment on the substrate. The substrate transfer apparatus 500 may include a dustproof mechanism for preventing particles generated by the drive unit provided inside from flowing outward. The substrate transfer apparatus 500 includes the housing 501, the elevator 502, the sealing belt 504 and the hand 506.

The housing 501 is a box shaped body. The housing 501 includes the opening 510 extending in a predetermined direction. The opening 510 has a rectangular shape in which the housing 501 extends in a straight line perpendicular to the front wall 511. The elevator 502 extends inside and outside the housing 501 through the opening 510. Then, a hand 506 is provided in a portion extending outside the housing 501.

In the substrate transfer apparatus 500 according to one or more embodiments, the elevator 502 includes the internal material 521a placed inside the housing 501 further than the opening 510, the external material 21b placed outside the housing 501 further than the opening 510. The hand 506 is provided on the external material 521b. The roller 522 is a cylindrical body extending in the width direction of the opening 510 and is provided near the opening 510 of the internal material 521a. The roller 522 is rotatably supported at both ends against the elevator 502 and is mounted so that it rotates around a rotation axis extending in the width direction of the opening 510. The roller 522 moves up and down by the sealing belt 504, and the elevator 502 moves up and down accordingly. Thereby, the hand 506 moves up and down.

The hand 506 includes adhesion pads 560a, 560b, 560c and 560d that grip the placed substrate W. The hand 506 may include passages, such as the structure of hand 270 shown in FIG. 2. Further, the adhesion pads 560a, 560b, 560c and 560d may be configured to perform a protruding operation from the hand 506 and a storage operation in the hand 506. A cover with an opening may be provided on the surface of the hand 506, and the adhesion pads 560a, 560b, 560c and 560d may protrude and retracted from the opening of the cover. The adhesion pads 560a, 560b, 560c and 560d include tip portions (not shown) having high adhesion, which protrude from the hand 506 and adhere to and grip the substrate W. Further, based on the control of the controller, the adhesion pads 560a, 560b, 560c and 560d are stored in positions that are not in contact with the substrate W. At that time, the substrate contact portions provided in the hand 506 are in contact with the substrate W. The substrate contact portions have lower adhesion than the adhesion pads 560a, 560b, 560c and 560d. The adhesion pads 560a, 560b, 560c and 560d are controlled by the controller through a passage provided inside the hand 506 to perform protruding and storing operations. The passage leading from the adhesion pads 560a, 560b, 560c and 560d is connected to the controller. Under the control of the controller, the tip portions of the adhesion pads 560a, 560b, 560c and 560d protrude from the opening of the cover, and the substrate W is in contact with the tip portions of the adhesion pads 560a, 560b, 560c and 560d. Next, under the control of the controller, the tip portions of the adhesion pads 560a, 560b, 560c and 560d are stored from the opening of the cover, and when the substrate W is placed, the substrate W is in contact with the substrate contact portion of the hand 506.

As described above, in the substrate transfer apparatus according to one or more embodiments, the adhesion pads 560a, 560b, 560c and 560d include a so-called direct-acting hand, and based on the control of the controller, the adhesion pads 560a, 560b, 560c and 560d protrude from the hand to increase the grip force of the substrate W, and are stored in the hand and not adhering to the substrate W to reduce the grip force of the substrate W on the hand. Thus, by exposing and storing the adhesion pads 560a, 560b, 560c and 560d, it may be possible to change the adhesion force at the time of transportation depending on the required accuracy. The entire contents of the U.S. Pat. No. 10,083,851, in particular the description of the substrate transfer apparatus having a so-called direct-acting hand, are incorporated herein by reference.

As described above, the substrate transfer apparatus according to one or more embodiments has been described, but is not limited thereto, and may be applied, for example, to a hand included in a panel transfer robot. The entire contents of the U.S. patent application publication No. 2005/0090257, in particular the description of the substrate transfer apparatus having a hand, are incorporated herein by reference. Further, one or more of the above-described embodiments may also be applied to the hand used in the FEFEM (Equipment front end module), which is an apparatus that is passed between the FOUP and the process apparatus when passing the substrate to the process device.

As described above, in the substrate transfer apparatus according to one or more embodiments, the adhesion pads protrude from the hand to increase the grip force of the substrate, and the adhesion pads are stored in the hand to make it not to adhere to the substrate to reduce the grip force of the substrate on the hand. In this way, by exposing and storing the adhesion pad, it may be possible to change the adhesion force at the time of transportation depending on the required accuracy. On the other hand, when the substrate is transported at high speed, the adhesion pads are retracted to release the adhesion between the adhesion pad and the substrate, and the substrate contact portions secure the substrate. This prevents deviation from the hand due to the force applied to the substrate. That is, the substrate contact portions physically prevent the substrate from popping out by the side wall in contact with the substrate. As a result, the hand may be able to stably transport the substrate even at high speed.

In addition, the substrate transfer speed may be optimized by changing the adhesion force of the hand to the substrate during transportation. Thereby, it may be possible to improve the productivity of the semiconductor apparatus by optimizing the transfer speed of the substrate, and it may also contribute to reducing substrate damage during substrate transportation. The substrate transfer apparatus according to one or more embodiments is particularly useful when suction grips or clamp grips may not be used in consideration of air contamination in the clean room and damage to the substrate.

Furthermore, in today's substrates, complex processing is performed and the friction coefficient of the surface state may differ depending on the type of substrate. The substrate transfer apparatus according to one or more embodiments may control the grip on the hand by consideration the friction coefficient of the substrate surface and other factors. As a result, it may be possible to flexibly handle various substrates.

The substrate transfer apparatus according to one or more embodiments has been described. Not limited thereto, for various types of substrate transfer devices, structures such as hands and adhesion pads used for substrate transfer devices according to one or more embodiments described above may be used.

One or more embodiments described above herein may be combined with each other as far as practicable within the scope of the intended embodiment. The above examples should be considered exemplary in all respects and not limiting. The illustrated and described embodiments may be extended to include other embodiments in addition to those specifically described without departing from the technical scope. The technical scope should be determined not only by the foregoing description, but also in the light of the specification containing equivalents. Thus, all configurations, including the equal technical scope, are intended to be included in the technical scope.

1. A substrate transfer apparatus comprising:
a base;
an elevator connected to the base to be freely raised and lowered; and
a substrate transfer mechanism comprising a hand that is movably connected to the elevator and transports a substrate, wherein the hand comprises:
a substrate contact portion that grips the substrate; and
an adhesion pad that protrudes from the hand and adheres to the substrate, and is stored in the hand so as not to adhere to the substrate, wherein
the substrate contact portion secures the substrate based on the adhesion pad stored in the hand.

2. The substrate transfer apparatus according to claim 1, wherein
an adhesive force of the adhesion pad to the substrate is higher than the adhesive force of the substrate contact portion.

3. The substrate transfer apparatus according to claim 1, wherein the hand comprises:
a cavity arranged inside the hand; and
a cover arranged to cover the cavity and comprising an opening arranged essentially in a center, wherein
the adhesion pad protrudes from the opening.

4. The substrate transfer apparatus according to claim 3, wherein the adhesion pad comprises:
a tip portion that protrudes from the opening; and
a flat portion arranged between the cavity and the cover to seal the cavity.

5. The substrate transfer apparatus according to claim 4, wherein the hand comprises:
a controller that controls protruding of the tip portion from the hand and storage of the tip portion into the hand; and
a passage connected with the cavity and transmitting the control of the controller.

6. The substrate transfer apparatus according to claim 5, wherein
the controller controls protruding of the tip portion from the hand and storage of the tip portion in the hand by changing air pressure in the cavity through the passage.

7. The substrate transfer apparatus according to claim 6, wherein
the tip portion protrudes from the hand in response to the controller controlling the air pressure in the cavity to a first pressure, and
the tip portion is stored in the hand in response to the controller controlling the air pressure in the cavity to a second pressure lower than the first pressure.

8. The substrate transfer apparatus according to claim 7, wherein
in response to the cavity becoming the second pressure, the flat portion moves to a cavity side, and the tip portion is stored in the hand.

9. The substrate transfer apparatus according to claim 8, wherein
the tip portion is stored inside the hand further than on a surface of the cover.

10. The substrate transfer apparatus according to claim 7, wherein
the first pressure is approximately ambient pressure.

11. The substrate transfer apparatus according to claim 7, wherein
the first pressure is positive pressure.

12. A substrate transfer method comprising:
placing a substrate so as to contact with an adhesion pad comprised in a hand of a substrate transfer apparatus;
transporting with the substrate placed on the hand;
storing an adhesion pad inside the hand;
placing the substrate so as to contact with substrate contact portion provided on the hand without contacting the adhesion pad; and
transporting with the substrate placed on the hand.

13. The substrate transfer method according to claim 12, wherein
an adhesive force of the adhesion pad to the substrate is higher than the adhesive force of the substrate contact portion.

14. The substrate transfer method according to claim 12, wherein the hand comprises:
a cavity arranged inside the hand; and
a cover arranged to cover the cavity and comprising an opening arranged essentially in a center, wherein
the adhesion pad protrudes from the opening.

15. The substrate transfer method according to claim 14, wherein
the storing the adhesion pad inside the hand: comprising
changing air pressure in the cavity; and
storing a tip portion in the hand.

16. The substrate transfer method according to claim 15, wherein
as the air pressure in the cavity changes, the adhesion pad moves to a cavity side, and the adhesion pad is stored in the hand.

17. The substrate transfer method according to claim 12, further comprising exposing the adhesion pad from the hand, wherein
the substrate is placed so as to contact with the adhesion pad in a state protruding from the hand.
